(19) United States
(12) Patent Application Publication
(10) Pub. No.: US 2001/0029137 A1
(43) Pub. Date: Oct. 11, 2001

(54) Plastic Component

(76) Inventor: Gerald Popp, Gottenheim (DE)

Correspondence Address: Jeffrey W. Salmon, Esq., WELSH & KATZ, LTD, 22nd Floor, 120 S. Riverside Plaza, Chicago, IL, 60606, US

(21) Appl. No.: 09/766,101

(22) Filed: Jan. 19, 2001

(30) Foreign Application Priority Data
Jan. 28, 2000 (DE) DE 100 03 595.7

(51) Int. Cl. D03D 9/00; D04H 1/00; D03D 15/00; D03D 19/00; B32B 5/18; B32B 5/24

(52) U.S. Cl. 442/30; 442/2; 442/4

(57) ABSTRACT

A plastic component with a base body made of a rigid foam material is connected with a grid-like net structure. According to one aspect of the present invention, the grid-like net structure has a tear-resistant core material that is surrounded by a mantle material. In this example, the mantle material is in frictional connection with the foam material of the base body that allows, for example, cracking off of fragments from the plastic component to be significantly reduced.

### FIELD OF THE INVENTION

The present invention generally relates to plastic components and, more particularly, to a plastic component having a base body made of rigid foam material that is provided with a grid-like net structure.

### BACKGROUND OF THE INVENTION

Plastic components are known, for example, from the article entitled “EPE and EPP: Characteristics and Current Applications in Europe,” by E. Meier in the collection Thermoplastische Partikelschaumstoffe—aktueller Stand und Perspektiven [Thermoplastic Particle Foams—Current Status and Perspectives], VDI-Verlag, Düsseldorf, 1996, pp 27-51. Such plastic components include a base body made of rigid foam, and are suitable for use in their intended applications. However, when the plastic components break, there is the danger that parts of the plastic components crack off and endanger, for example, the vehicle occupants when the plastic component is used as an instrument panel.

### BRIEF SUMMARY OF THE INVENTION

It is desirable to provide a plastic component comprising a base body and a grid-like net structure that is connected to the base body on at least on one side surface thereof. According to one aspect of the present invention, the grid-like net structure comprises a tear resistant core material that is surrounded by a mantle material, wherein the mantle material is friction connected to the base body. Providing such a plastic component affords a number of advantages. First, cracking off of fragments of the plastic component during use is minimized. Second, commercially acceptable plastic components can be manufactured in an easy and cost effective manner. Third, plastic components are relatively light, yet are rigid energy absorbing bodies that are utilizable in a variety of different applications.

Other features and advantages of the invention will become apparent from the description that follows.

### BRIEF DESCRIPTION OF THE DRAWINGS

The objects and advantages of the present invention will become more readily apparent to those of ordinary skill in the relevant art after reviewing the following detailed description and accompanying drawings, wherein:

FIG. 1 is a perspective view of a partial cut through a particle foam device with a plastic component according to one embodiment of the present invention;

FIG. 2 is a cross-sectional view of the plastic component shown in FIG. 1; and

FIG. 3 is a perspective view of a partial cut through a particle foam device with a plastic component according to a second embodiment of the present invention.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description Of The Invention”) relates to a requirement of the United States Patent Office, and should not be found to be limiting to the subject matter disclosed and claimed herein.

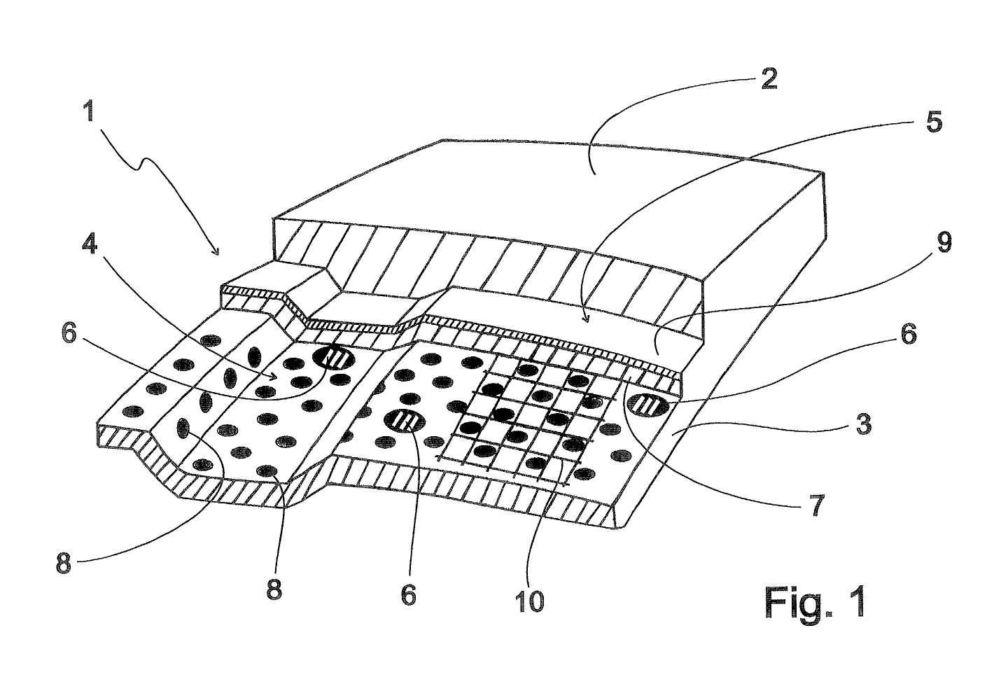

FIG. 1 shows a perspective view of a partial cut through a detail of a particle foam device 1 that has a tool matrix 2 and a tool matrix 3 located opposite the tool matrix 2. The tool matrix 2 and the tool matrix 3 enclose a cavity 4 containing a plastic component 5. In the illustrated embodiment of the invention, the plastic component 5 is shown as an instrument panel 5 for motor vehicles. However, it should be understood that plastic components in accordance with aspects of the invention disclosed herein may be utilized in other automotive applications such as, for example, door trims, spar panels, knee protectors, tool shelves, trunk fillers, backrests, headrests, armrests and the like. It also should be further understood that plastic components in accordance with aspects of the present invention may be utilized in a variety of non-automotive applications such as, for example, packing or transport containers for technical parts, bicycle helmets, cooling boxes or the like.

Referring to FIG. 1, the tool matrix 3 has a number of particle-entry openings 6 through which ball-like or cylinder-like closed or open particles can be introduced into the cavity 4 through a particle introduction unit (not shown in FIG. 1) to form a base body 7 made of solid foam material with open and/or closed cells distributed across the complete mass. In addition, the tool matrix 3 is provided with a number of steam jets 8 arranged at generally regular intervals through which hot steam with a temperature above the melting point of the particle material can be introduced into the cavity 4 for solidifying the individual particles.

The instrument panel 5 in the design according to FIG. 1 also has a decorative layer 9 that is connected with the base body 7 directly or by means of an adhesive over the whole surface. In addition, the instrument panel 5 is provided with a net structure 10 on the side opposite the decorative layer 9 in certain areas which is made of a tear-resistant core material and a mantle material surrounding the core material in frictional connection with the base body 7. Preferably, the net structure 10 consists of crosswise woven individual strands, and the core material is formed from a number of individual fibers that have a higher tensile strength than the mantle material and the base body 7.

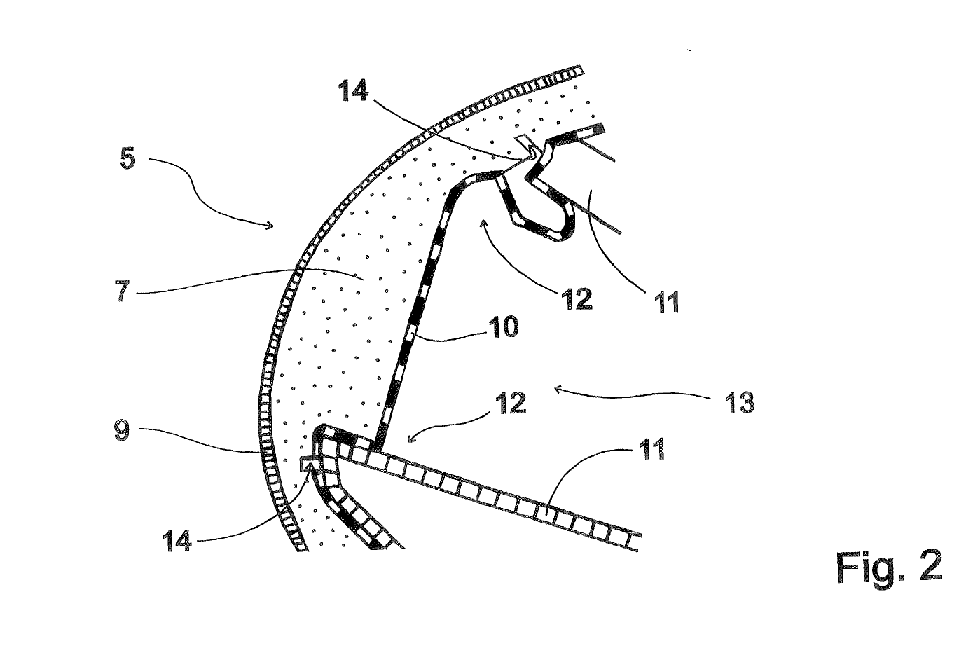

FIG. 2 shows the instrument panel 5 as a plastic component in the embodiment according to FIG. 1 in a cross section. The instrument panel 5 is attached to carriers 11 and provided with a net structure 10 that is prefabricated and free-standing in the attachment areas 12 to hold the carriers 11 and arranged, for example, in the area of an airbag deployment channel 13. At the rim sides of an airbag deployment channel 13, a default break line 14 is cut into the base body 7 by laser cuts, for example, and, if needed, also in the decorative layer 9. At one rim side, the net structure 10 is separated while it is preferably protruding at the other rim side and functions like a hinge.

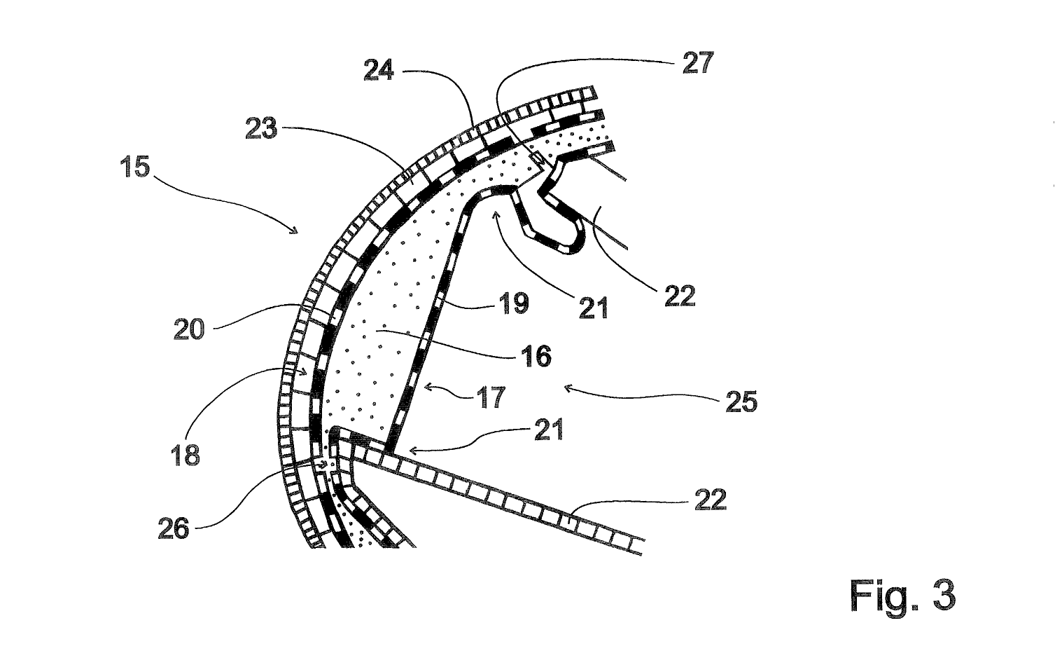

FIG. 3 shows a cross-section of an instrument panel 15 as a plastic component under the invention in a second embodiment. The instrument panel 15 in FIG. 3 has, like the instrument panel 5 in FIGS. 1 and 2, a base body 16 in frictional connection with a first net structure 19 at opposing surface sides 17, 18. The net structures 19, 20 in the second embodiment are formed like the net structure 10 in the first embodiment. The first net structure 19 is free-standing and prefabricated in the attachment areas 21 for holding the carrier 22, while the second net structure 20 abuts completely against the base body 16. The second net structure 20 is in frictional connection with an elastic body 23 at the side opposite the base body 16 via the mantle material as the adhesive. The elastic body 23 is connected, in turn, to the decorative layer 24 on its outside by means of an adhesive.

In the area of the airbag deployment channel 25 of the instrument panel 15, a first default break line 26 is formed by material tapering at one rim side; both net structures 19, 20 are separated along the break line 26. A second default break line 27 is provided at the other rim side by tapering. The second net structure is arranged between the base body 16 and the decorative layer and is separated along the default break line 27, while the first net structure 19 is formed in one piece and it protrudes like a hinge in this area.

The base bodies, 16 of the above plastic-component embodiments according to the invention are manufactured, for example, from an expandable polypropylene material, from a so-called PP-E foam or from an expandable polystyrene material with polyphenylene oxides, a so-called EPS/PPO foam as foam materials. The tool steam pressure for fusing is between c. 200 kilo pascal and c. 500 kilo pascal for the so-called autoclave foams or between c. 200 and c. 700 kilo pascal for the so-called extrusion foams. The steam temperature is created in the cavity 4 above the steam pressure. The foam densities are between c. 15 grams per liter and c. 200 grams per liter and sometimes above for attaining a higher temperature stability and rigidity.

The decorative layers 9, 24 can be in one or multiple layer construction. In a multiple layer construction, the upper layer facing away from the base body 7, 16 is formed with a two-layer decor, for example, with a film made of a thermoplastic polyolefin, a so-called TPO film, as well as a partially netted PP foam. In a multiple layer construction, the upper layer in another embodiment is constructed as a three-layer decor formed, for example, of the TPO film, a partially netted PP foam as well as a PP film. The bottom layer that is facing the base body 7, 16 is preferably designed as an adhesive.

In another embodiment, the decorative layers 9, 24 are formed by a so-called slush skin made of thermoplastic polyolefin (TPO), polyvinyl chloride (PVC) or thermoplastic polyurethane (TPU) that can be designed in one or two layers. In a two-layer design, the layer facing the base body 7, 16 is made of a foam that has adhesive qualities with respect to the material of the base body 7, 16, a PP-E foam, for example.

The mantle material of the net structures 10, 19, 20 is a PP-E foam or polypropylene for the connection with PP-E foams or an EPS/PPO foam or EPS for the connection with EPS/PPO foams. The mantle materials have a similar melting point as the material of the base body 7, 16.

The core material of the net structures 10, 19, 20 is preferably made of fibers of polyester, aramide (Kevlar), polyamide, polycryenitril, polyurethane polyolefins such as polypropylene, for example, or of carbon fibers, EVA fibers or PES fibers. For practical reasons, the melting point of such materials is clearly higher than the melting point of the mantle material in order to avoid a weakening of the net structure during the connection with the respective base body 7, 16. The frictional connection of the net structures 10, 19, 20 is accomplished by melting together with the respective base body 7, 16, by melting the mantle material in a sintering process or by friction welding or ultrasound welding outside a foam mold, respectively, after the manufacture of the base body 7, 16.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims when the claims are properly interpreted.

What is claimed is:

1. A plastic component, comprising:
a base body made of a rigid foam material, said base body having a first surface; and
a grid-like net structure that is connected at least to the first surface of said base body, said net structure including a tear-resistant core material that is surrounded by a mantle material, said mantle material being in frictional connection with the rigid foam material of said base body.

2. The plastic component of claim 1, wherein said rigid foam material and said mantle material both comprise a polypropylene material with a certain melting point.

3. The plastic component of claim 1, wherein said core material has a higher melting temperature than a melting point of said rigid foam material and a melting point of said mantle material.

4. The plastic component of claim 1, wherein said grid-like net structure comprises individual strands that are woven in a cross-like manner to define a plurality of crossing areas.

5. The plastic component of claim 4, wherein said mantle material is connected in a number of said crossing areas of said individual strands.

6. The plastic component of claim 1, wherein said core material is formed from a multitude of fibers.

7. The plastic component of claim 1, wherein said mantle material is a thermoplastic foam.

8. The plastic component of claim 1, wherein said base body is connected at two opposite surface sides with a respective portion of said grid-like net structure.

9. The plastic component of claim 1, further comprising a decorative layer that is connected on a portion of said grid-like net structure.

10. The plastic component of claim 1, further comprising an elastic body, said elastic body being in frictional connection with at least a portion of said grid-like net structure.
